(19) United States
(12) Patent Application Publication
(10) Pub. No.: US 2025/0145907 A1
(43) Pub. Date: May 8, 2025

(54) CLEANING AGENT PREPARATION, METHOD FOR THE PREPARATION OF A CLEANING AGENT PREPARATION AND METHOD FOR THE PREPARATION OF A CLEANING AGENT

(71) Applicant: AVET AG, Rüti/Zürich (CH)

(72) Inventor: Roland SACKS, Cham (CH)

(73) Assignee: AVET AG, Rüti/Zürich (CH)

(21) Appl. No.: 18/837,986

(22) PCT Filed: Feb. 16, 2023
(86) PCT No.: PCT/EP2023/053912

§ 371 Date: Aug. 13, 2024

(30) Foreign Application Priority Data
Feb. 16, 2022 (DE) 10 2022 103 668.5

(51) Int. Cl. C11D 1/37; C11D 1/14; C11D 1/28; C11D 3/37; C11D 11/00; C11D 17/04

(52) U.S. Cl. CPC C11D 1/37; C11D 3/3753; C11D 11/0082; C11D 17/049; C11D 1/146; C11D 1/28

(57) ABSTRACT

A detergent preparation (3), such as more particularly a laundry detergent preparation, which is water-soluble and which includes at least one first and one second surfactant (16, 17), the second surfactant (17) having a lower melting temperature than the first surfactant (16) and the melting temperature of the detergent preparation (3) being at least 20° C., preferably at least 40° C., below the melting temperature of the first surfactant (16).

### CROSS-REFERENCE TO RELATED APPLICATIONS

This application is a 371 National Phase of PCT/EP2023/053912, filed Feb. 16, 2023, which claims priority to German Patent Application No. 10 2022 103 668.5, filed Feb. 16, 2022, both of which are incorporated herein by reference as if fully set forth.

### TECHNICAL FIELD

The invention relates to a detergent preparation which is water-soluble and which includes at least one first and one second surfactant.

The invention is further concerned with a method for producing a detergent preparation of the abovementioned kind.

The invention is further concerned with a water-soluble cleaning product and with a method for producing a water-soluble cleaning product.

### BACKGROUND

Detergent preparations are used diversely, especially as active ingredient combinations, in cleaning products and are indispensable for the cleaning of various articles, objects, and surfaces. In particular, for instance, detergent preparations in laundry detergents are important for the cleaning of textiles, precursors thereof, and leather products. Detersive substances employed are frequently surfactants; the surfactant content in detergent preparations is usually only 1-40% percent by weight and hence the cleaning performance may be relatively low.

The production of detergent preparations and cleaning products, especially those containing surfactant, often presents problems: on the one hand, the requirements imposed on the surfactants in terms of their efficacy and their degradability are exacting, and, on the other hand, the processing thereof into a user-friendly end product oftentimes entails a high degree of cost and complexity.

### SUMMARY

It is therefore an object of the invention to improve detergent preparations, more particularly laundry detergent preparations, and their production. A further object of the invention is to provide an improved cleaning product and associated method.

To achieve the stated object, one or more of the features disclosed herein are provided. In particular, accordingly, to achieve the stated object in the context of a detergent preparation of the kind described above, the invention proposes that the second surfactant has a lower melting temperature than the first surfactant and that a melting temperature of the detergent preparation is at least 20° C. below the melting temperature of the first surfactant. The melting temperature of the detergent preparation is preferably at least 40° C. below the melting temperature of the first surfactant.

The stated melting temperatures are based in each case on standard conditions, more particularly on a standard pressure.

It should be borne in mind that in accordance with the achievement of the object, not only the first and the second surfactant but also the detergent preparation which includes the two surfactants has a melting temperature. This preparation as such is therefore meltable. The detergent preparation is therefore a meltable mixture. The detergent preparation differs here from a mixture in respect of which, on heating, a single component first melts and separates from the rest of the mixture. The detergent preparation, in accordance with the objective achieved, is retained as a mixture through the melting process and can also be solidified again after melting has taken place. In this case, components, especially the first and the second surfactant, remain mixed with one another. The mixture can then also be melted again once more.

Through the use of a first and a second surfactant, advantageously, a particularly high cleaning performance can be achieved, especially since the detergent preparation is water-soluble. For achieving an optimal cleaning effect, the surfactants used in the case of a detergent preparation may be anionic and/or cationic and/or zwitterionic and/or nonionic.

A water-solubility of the detergent preparation may be characterized in that the detergent preparation dissolves in water through contact with the latter. It is not necessary here for a solution in the chemical sense to form. A suspension may also form.

The detergent preparation preferably has a water-solubility at least at +8° C. This may be advantageous especially when the detergent preparation is embodied as a laundry detergent preparation. It is therefore possible for objects, preferably textiles, to be cleaned at a temperature from as low as +8° C.

The detergent preparation may in particular be a laundry detergent preparation. It may also be a different kind of detergent preparation such as, for instance, a polish preparation.

A water-soluble detergent preparation may have diverse possible uses, for cleaning different objects such as, preferably, textiles. Accordingly, a cleaning product is improved.

A cleaning product of the invention may further be improved by the use of a first and a second surfactant. A particular selection of the two surfactants may be particularly advantageous if the detergent preparation comprises further detersive substances, as hereinbelow described and/or claimed and/or known to the skilled person. Thus an interaction of the surfactants with one another and/or with a further detersive substance may particularly improve the cleaning performance of the detergent preparation.

The first and second surfactants may be of advantage in particular in the context of a method for producing a detergent preparation of the kind hereinbelow described and/or claimed.

The use of two surfactants having different melting temperatures may lead to an advantageous lowering of the melting temperature of the detergent preparation. The lowering of the melting temperature has the advantage that the detergent preparation can be melted and processed further at relatively low temperatures. Thus it has surprisingly emerged that a lowering of the processing temperature of the detergent preparation has a positive impact on the quality of a cleaning product produced from said preparation. For example, through a lowered processing temperature, it is possible to prevent the decomposition of substances which are used in the production of a cleaning product and which are heated as a result of melting of the detergent preparation. Such prevention may have the effect, for example, that additives used in the production of a cleaning product, such as enzymes or fragrances, for instance, are preserved.

Furthermore, as a result of the reduction in a processing temperature through the lower melting temperature, in the case of a detergent preparation of the invention, the production of a cleaning product may become more cost-effective.

A decrease in the melting temperature of the detergent preparation by 20° C. relative to the melting temperature of the first surfactant may already trigger significant quality boosts. Cleaning products of particularly high quality may be produced from detergent preparations whose melting temperature is more than 40° beneath the melting temperature of the first surfactant. The first surfactant is preferably the surfactant of the detergent preparation having the highest melting temperature.

It may in particular be the case that the lowering of the melting temperature of the detergent preparation that is caused by the second surfactant is at least 20° C., preferably at least 40° C.

It may be the case that further ingredients of the detergent preparation produce a lowering of the melting temperature of the detergent preparation. Thus, as described hereinbelow, the detergent preparation may comprise a third or further surfactants which produce a temperature lowering. Other ingredients such as additives may also produce a lowering of the melting temperature of the detergent preparation.

In one advantageous configuration, it may be the case that the detergent preparation comprises a third surfactant having a melting temperature which is beneath the melting temperature of the second surfactant. Accordingly, a detergent preparation having a particularly high cleaning performance can be embodied, and this may be of advantage, particularly in the context of laundry detergent preparations/laundry detergents.

It may also advantageously be the case that more than three surfactants are used in a detergent preparation mentioned above or as claimed hereinbelow, in order to be able to produce a particularly effective cleaning product. In that case, these further surfactants have a melting temperature which is preferably at least lower than the melting temperature of the first, preferably of the second surfactant. Accordingly, the melting temperature of the detergent preparation may be further lowered, so making it possible to particularly improve a method for producing a detergent preparation and, respectively, a cleaning product.

The first surfactant preferably has a melting temperature of at least 120° C. The second surfactant preferably has a melting temperature of not more than 120° C. The combination of such high-melting and low-melting surfactants may afford particular advantages. For instance, there are highly effective high-melting surfactants whose melting temperature, however, may present problems for subsequent processing during cleaning product production. A combination with low-melting surfactants may therefore be advantageous as already described above. Particularly among the low-melting surfactants, there are a host of suitable surfactants available that are obtainable on a purely natural basis. These surfactants may be optimally combined with a high-melting surfactant, which may also have been produced synthetically.

In one advantageous configuration, it may be the case that the first and/or the second and/or the third surfactant are anionic. Accordingly, a detergent preparation can be biodegraded to a great extent, thus providing a particularly eco-friendly detergent preparation. Preferably all the surfactants of a detergent preparation are anionic, so that a particularly high fraction of the detergent preparation can be biodegradable.

In one advantageous configuration of the detergent preparation of the invention, it may be the case that the melting temperature of the first surfactant is greater than 160° C., more particularly greater than 200° C. Hence, for example, highly effective synthetic surfactants, sodium lauryl sulfate derivative for example, may be used in a detergent preparation, thereby enabling the production of cleaning products having a particularly high cleaning performance.

Alternatively or additionally, it may be the case that the melting temperature of the second surfactant is not more than 100° C., more particularly not more than 80° C. It is possible accordingly for preferably surfactants of plant or animal origin to be used as second surfactant, being relatively easy, inexpensive and resource-sparing in their extraction.

Alternatively or additionally, it may be the case that the melting temperature of a third surfactant, more particularly of the abovementioned third surfactant, is not more than 80° C., preferably not more than 40° C.

In one advantageous configuration, it may be the case that the melting temperatures of the first and of the second surfactant differ by more than 50° C. More preferably the melting temperatures differ by more than 100° C. Configurations of this kind can on the one hand lead to an effective lowering of the melting temperature and on the other hand make it possible to use a particularly large number of surfactants, such as surfactants of natural origin, for example.

In one advantageous configuration, it may be the case that the melting temperature of the detergent preparation is in a range between 130° C. and 180° C. It is possible accordingly for relatively thermally unstable additives to be processed in a detergent preparation. Furthermore, processing of the detergent preparation, in particular to form powder or granules, can be performed more rapidly, since cooling and hardening of the melted detergent preparation can take less time because of the lowered melting temperature.

In one advantageous configuration, it may be the case that the detergent preparation has a surfactant fraction of between 40 and 70 percent by weight. A surfactant fraction of 40 to 70 percent by weight may ensure a particularly high cleaning effect.

Weight percentages and weight data values are indicative in each case of a quantity which is based on the dry mass, i.e., on a solid state, of the components.

Alternatively or additionally, it may be the case that the first surfactant in the detergent preparation has a weight fraction of between 30 and 60 percent by weight. Alternatively or additionally, it may be the case that the second surfactant in the detergent preparation has a weight fraction of between 7.5 and 20 percent by weight. An excess of the first surfactant over the second surfactant may be advantageous especially when the first surfactant has a particularly high cleaning effect but has a particularly high melting temperature—at least 160° C., for example. In that case, the melting temperature of the detergent preparation may be lowered by the second surfactant, being for example, as described above or claimed hereinbelow, between 130° C. and 180° C., which is advantageous.

It is preferably the case that the abovementioned third surfactant in the detergent preparation has a weight fraction of between 15 and 30 percent by weight. This allows a melting temperature of the detergent preparation to be lowered still further, enabling the use of a surfactant having a particularly high melting temperature.

In one advantageous configuration, it may be the case that the first surfactant is sodium lauryl sulfate or a sodium lauryl sulfate derivative. Sodium lauryl sulfate or sodium lauryl sulfate derivatives are highly effective, fat-dissolving surfactants which, moreover, are relatively favorably priced, and can therefore be used advantageously for producing an improved detergent preparation.

Preference is thus given to using sodium lauryl sulfates having a melting temperature of 206° C.

In particular, it may advantageously be the case that the sodium lauryl sulfate derivative is sodium lauryl ether sulfate, which is particularly fat-dissolving and good value.

In one advantageous configuration, it may be the case that the second and/or a third surfactant, the abovementioned third surfactant for example, is/are of plant origin. It is possible accordingly to use, as second and/or third surfactant, compounds which advantageously are easy to obtain and have good biodegradability. It is therefore even possible to produce a vegan cleaning product, which may be appealing to customers.

In particular, it may be the case here that the second and/or the third surfactant are obtained from coconut fat and/or palm fat. For example, it may be the case that the second surfactant is sodium cocoyl isothionate or a derivative thereof, with a preferable melting temperature of 75° C. The third surfactant may be sodium cocosulfate or a derivative thereof, with a preferable melting temperature of 40° C. These two stated surfactants are obtained from coconut fat, and so, when using a second and at least one third surfactant, the surfactants can originate from the same basic resource—this may be advantageous logistically and in technical process terms.

In one advantageous configuration, it may be the case that the detergent preparation comprises at least one polymer. In that case the polymer may have a similar melting temperature to a surfactant, more particularly to the first surfactant. In the context of polymers it may be advantageous that they can be used, for example, as colorants, as thickeners or as opacifiers, allowing a cleaning product to be improved. With particular advantage, polymers may serve as dispersing assistants for improving the transport of dirt particles from the product, and they may therefore prevent dirt particles redepositing during a cleaning or laundering process.

With polymers, it is preferably the case that they are biodegradable, so that they do not accumulate in the environment.

In preferred applications, it may be the case that there is a weight fraction of polymers in the detergent preparation of 1 to 10, more particularly 1.5 to 5, percent by weight.

In particular, polyvinyl alcohol may be provided as a polymer. Polyvinyl alcohols are water-soluble and can easily be precipitated from dispersion-containing wastewaters and disposed of. As a result, polyvinyl alcohols can be used with particular preference in detergent preparations, such as more particularly in laundry detergent preparations. Furthermore, polyvinyl alcohols have a melting temperature in the range from 195° C. to 245° C. By virtue as well of their resistance toward oils, fats, and organic solvents, polyvinyl alcohols are especially suitable as a component of a detergent preparation.

Alternatively or additionally, acrylic polymers or other polymers known to the skilled person may also be used.

It may also be the case with particular advantage that the polymer is a soil release polymer. This term relates to water-soluble polycondensates which disperse in water and are based on dicarboxylic acids, diols, or to cellulose ethers. As a result, the graying of textiles can be prevented, especially when anionic surfactants are comprised in the detergent preparation. Cleaning products can therefore be particularly improved.

In one advantageous configuration, it may be the case that the detergent preparation comprises at least one temperature-stable, nonmelting bleaching agent. Accordingly, bleaching agents which can be used in particular are compounds forming oxygen or chlorine, especially percompounds (that is, molecules with an oxygen-oxygen bond) such as sodium percarbonate. An advantageous feature of bleaching agents may be that, in addition to their bleaching effect for the removal of stubborn stains, they may also have antibacterial effects.

It may preferably be the case that the bleaching agent or agents in the detergent preparation have a weight fraction of 3 to 15 percent by weight.

Alternatively or additionally, it may be the case that the detergent preparation comprises at least one complexing agent. The water hardness can be reduced accordingly. Furthermore, by means of complexing agents, bleaching agents can be stabilized and the cleaning power of surfactants improved. Complexing agents that may be used are, in particular, citrate compounds, polyacrylic sodium salts, polyethylene glycol.

Alternatively or additionally, it may be the case that the detergent preparation, for advantageous water softening, comprises builders, preferably silicates, more preferably zeolite. In that case, the weight fraction of the builder or builders in the detergent preparation may be preferably between 2 and 25 percent by weight.

Alternatively or additionally, it may be the case that the detergent preparation comprises at least one enzyme. Enzymes used are preferably lipases and/or cellulases at a preferred fraction of 0.05 to 2% by weight of the detergent preparation. Through the use of enzymes, a detergent preparation may be given a usage-specific embodiment.

It is advantageously now possible for less thermally stable enzymes to be used in a detergent preparation, since a melting temperature of a detergent preparation, as described above, can be lowered, thereby allowing the detergent preparation to be further-processed at a further-processing temperature which in particular is not denaturing for the less thermally stable enzymes.

Alternatively or additionally, it may be the case that the detergent preparation comprises at least one fragrance. In particular, then, essential oils may be used. A detergent preparation may therefore have a pleasing odor, and this may be particularly user-friendly.

In one advantageous configuration, it may be the case that the detergent preparation at room temperature is in a solid phase, more particularly in the form of granules or in monolithic form. Accordingly, the detergent preparation can be stored effectively and/or easily processed to form a cleaning product subsequently.

In a further advantageous configuration, it may be the case that the detergent preparation is anhydrous. This may allow the detergent preparation to retain its desired consistency in the event of heating. If a water fraction were present, the heating, in particular above 100° C., would cause water to emerge in the form of water vapor from the detergent preparation. This preparation could then swell up, to the detriment of further processing, by application to a pad in the form of a melt film, for example.

To achieve the stated object, the invention provides the features of the co-independent claim directed to a water-soluble cleaning product. In particular, accordingly, to achieve the stated object in the context of a water-soluble cleaning product, it is proposed that the product has an inner layer and an outer pad, where a meltable detergent preparation is applied on the inner layer between a first side of the inner layer and the outer pad, and where additionally it is the case that the outer pad, the inner layer, and the detergent preparation are water-soluble. The detergent preparation is preferably embodied as described above. More preferably, the detergent preparation is embodied in accordance with one of the claims directed to such a preparation. As a result, the cleaning product may be activatable in contact with water, so that the detergent preparation, more particularly the surfactants stated above, become detersive. It may additionally be advantageous in the context of a water-soluble cleaning product of this kind that the cleaning product can be disposed of in a particularly simple and environmentally benign manner. The advantage of a detergent preparation applied to an inner layer may be seen as that of allowing the detergent preparation to be protected from external influences. Likewise, a user may be protected from components of the detergent preparation that, for example, are irritants to skin. The cleaning product is preferably a laundry detergent or a polish.

The cleaning product may preferably be embodied as described below:
A) Cleaning product as described above.
B) Cleaning product as described above, characterized in that a second side of the inner layer is covered by a second water-soluble outer pad, more particularly wherein the detergent preparation is also applied on the second side of the inner layer. As a result of this, advantageously, more detergent preparation can be applied for the same surface area of an outer pad. It may also be advantageous that a second outer pad can be used to achieve even greater protection of the detergent preparation and of the user.

It may also be the case that the cleaning product has more than one inner pad and/or that at least two layers of the detergent preparation or the like are applied such that, advantageously, the detergent preparations can be activated and can be dissolved in the added water at different temperatures and/or within different exposure times.
C) Cleaning product having the features as described under A) or
B), characterized in that the inner layer has at least one water-soluble inner pad which bears the laundry detergent preparation. As a result, a cleaning product can be produced advantageously, especially when the detergent preparation, as described above or claimed hereinbelow, is present in a solid phase and is joined by being scattered onto the inner pad, with subsequent melting. Subsequently, the inner pad bearing the cleaning product can then be advantageously compressed with two outer pads.
D) Cleaning product having the features as described under A), B) or C), characterized in that the outer pads and/or the at least one inner pad consist of water-soluble fiber polymers such as, for example, polyvinyl alcohols and/or alginates and/or polyacrylic acid and/or cellulose. In this case, the acceptance and handling of the cleaning product benefit substantially if at least the outer pads, produced from fiber-containing material, have a paperlike tactility.
E) Cleaning product having the features as described under A), B), C) or D), characterized in that a melting temperature of the outer pads and/or of the at least one inner pad is higher, more particularly higher by at least 30° C., than the melting temperature of a surfactant mixture of the detergent preparation as described above or claimed hereinbelow. As a result, a method for producing a cleaning product can be particularly gentle for the detergent preparation and economical.
F) Cleaning product having the features as described under any of the sections A) to E), characterized in that the meltable detergent preparation can be applied to the at least one inner layer of the cleaning product preferably by scattering or powder application, slot die coating or engraved roll application. Accordingly, a production method can be performed with preferably known production technologies, allowing a detergent preparation of the invention to be processed to form a cleaning product in a particularly economical manner, so that a selling price of the cleaning product can be particularly customer-friendly.
G) Cleaning product having the features as described under any of the sections A) to F), characterized in that an application rate of the meltable detergent preparation claimed as above or hereinbelow is preferably between 400 g/m² and 1200 g/m². The application rate of the detergent preparation can therefore be optimally adapted to the eventual cleaning product.

Hence the cleaning product may preferably have a portionable embodiment, allowing a user advantageously to carry out a cleaning procedure with precise metering of the detergent preparation. In the case of a textile laundering procedure, for example, it may be advantageous to use 10 g to 80 g of the laundry detergent preparation.

To achieve the stated object, the invention provides the features of the co-independent claim directed to a method for producing a detergent preparation as described above or claimed hereinbelow. In particular, accordingly, to achieve the stated object in the context of such a method, it is proposed in accordance with the invention that ingredients of the detergent preparation are mixed with one another in a mixing vessel at a temperature which is above a melting temperature of the detergent preparation, more particularly above a melting temperature of the first surfactant, and in that after the mixing, the melted mixture is cooled to form a solid. The first surfactant is preferably placed first into the mixing vessel. This allows a detergent preparation having the desired properties to be produced.

In particular, after solidification and/or crystallization, a mass, more particularly a monolithic mass which forms, can be granulated. It may advantageously be the case here that the detergent preparation is processed by grinding and homogenizing to form a scatterable, free-flowable powder. Accordingly, the detergent preparation produced in accordance with the invention can be optimally stored and processed uniformly in the cleaning product, preferably as described above, this being an advantage.

Alternatively or additionally, to achieve the stated object, the invention provides the features of the co-independent claim directed to a method for producing a water-soluble cleaning product. In particular, accordingly, to achieve the stated object in the context of such a method, it is proposed in accordance with the invention that the cleaning product is embodied in accordance with the invention, more particularly as described above and/or as claimed hereinbelow, and that the detergent preparation is applied to the inner layer and then is covered by the outer pad and that then the inner layer, the outer layer, and the detergent preparation in between them are compressed together.

As a result, advantageously, a water-soluble cleaning product can be produced, in particular with a detergent preparation of the invention. The compressing together of the inner layer, the outer layer, and the detergent preparation in between them allows the cleaning product to be brought into a stable, user-friendly form. The effectiveness of the compressing is increased if, as hereinbelow described and claimed, the inner layer and/or the outer layer are joined with the detergent preparation to form a firm assembly.

Compressing may be carried out in particular by calendaring or other techniques known to the skilled person.

In one development of the method for producing a cleaning product, it may be the case that before the detergent preparation is applied to the inner layer, at least one further substance is applied to the inner layer, more particularly wherein the at least one further substance comprises preferably a temperature-stable, non-melting bleaching agent and/or a complexing agent and/or a builder and/or an enzyme and/or a fragrance. A cleaning product, more particularly as described above, may therefore be provided with a further substance, preferably with—as stated above—a temperature-stable, non-melting bleaching agent and/or a complexing agent and/or a builder and/or an enzyme and/or a fragrance. From these groups of substances just stated, use may be made with particular preference, alternatively or additionally, of thermally unstable compounds.

The detergent preparation may be applied preferably as a melt film or else as granules to the inner layer.

Granules comprise grains of different sizes and in particular, as well as relatively coarse grains, also comprise pulverulent grains.

Granules may be applied for example by scattering.

A melt film may be applied for example by heating and extrusion from an extrusion apparatus.

In one development of the method for producing a cleaning product, it may be the case that for applying the detergent preparation, it is melted at a temperature beneath the melting temperature of the first surfactant and then is applied as a melt film to the inner pad. Advantageously, therefore, the detergent preparation can be processed and applied at a relatively low temperature, thus preventing decomposition of or damage to components of the cleaning product during the production of the cleaning product.

Alternatively or additionally, it may advantageously be the case that the detergent preparation is applied in the form of granules to the inner layer and then is melted beneath the melting temperature of the first surfactant.

It may advantageously be the case that the detergent preparation and the inner layer by which the detergent preparation can be fused together to form an assembly consist of an identical polymer, preferably of a polyvinyl alcohol.

In one development of the method for producing a cleaning product, it may be the case that the inner layer and the detergent preparation are joined to form a firm assembly in particular at a temperature in the range between 120° C. to 240° C. Therefore, more particularly at low melting temperatures in the range from 150° C. to 180° C., a firm assembly can be produced in a particularly gentle way from the inner layer and the detergent preparation, allowing at least thermally unstable compounds, more particularly the abovementioned thermally unstable compounds, to be used in a cleaning product.

### BRIEF DESCRIPTION OF THE DRAWINGS

A method for producing a cleaning product, comprising a detergent preparation of the invention, is now described more closely by means of an exemplary embodiment, but is not confined to this exemplary embodiment. Further exemplary embodiments come about through combination of the features of individual or multiple claims or of above-described invention variants with one another and/or with individual or multiple features of the exemplary embodiment.

FIGS. 1A-1J show a method for producing a cleaning product as described above, comprising a detergent preparation of the invention.

### DETAILED DESCRIPTION

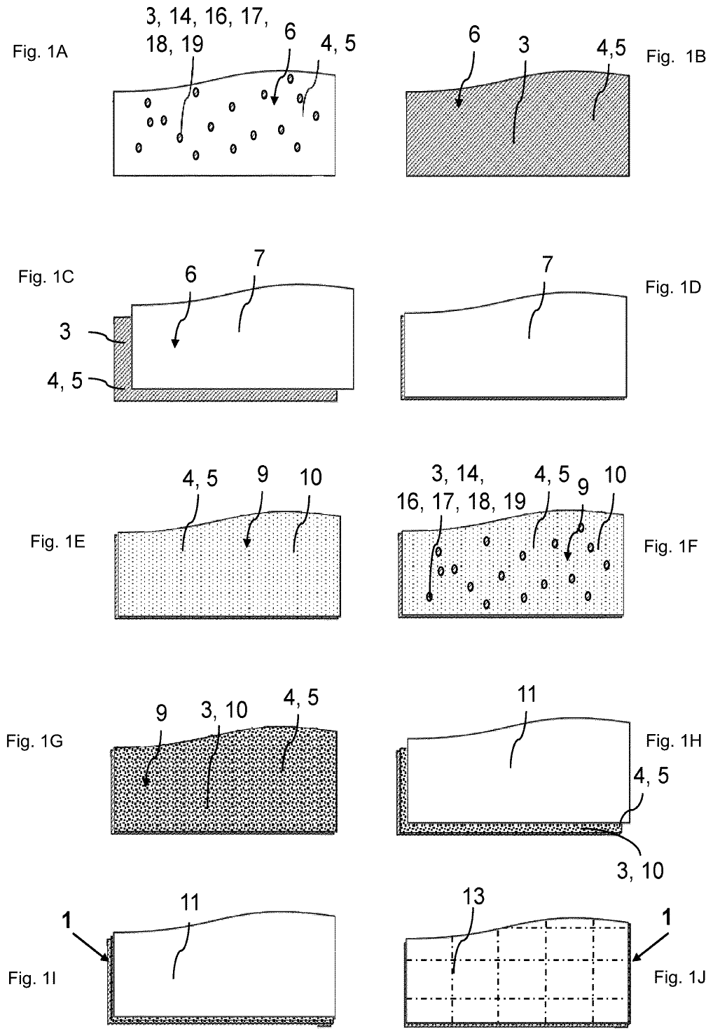

In the production, as represented in FIGS. 1A to 1J, of a cleaning product 1 as described above, a detergent preparation 3 of the invention is processed that includes a first, a second, and a third surfactant 16, 17, 18 and a polymer 19, more particularly polyvinyl alcohol (FIG. 1A, 1F). Other additives, such as, for example, a temperature-stable, nonmelting bleaching agent and/or a complexing agent and/or a builder and/or an enzyme and/or a fragrance 10, may be present in the detergent preparation 3 in order to enable customer-appropriate production of an optimal cleaning product 1 having the above-described advantages. The additives used may include thermally unstable compounds and/or compounds with little temperature stability.

The detergent preparation 3 is embodied as a laundry detergent preparation. As can be seen in FIG. 1I and FIG. 1J, the detergent preparation is processed to form a cleaning product 1 which is embodied as a laundry detergent and can be portioned via cut edges 13.

The cleaning product 1 is particularly detersive, owing to the use as first surfactant 16 of sodium lauryl sulfate or a sodium lauryl sulfate derivative. Through the use of the second surfactant 17, especially sodium cocoylisothionate or a derivative thereof, and of the third surfactant 18, especially sodium cocosulfate or a derivative thereof, the melting temperature of the detergent preparation 3 during production thereof is brought at least 20° C. below the melting temperature of the sodium lauryl sulfate, so making the method for producing the detergent preparation 3 particularly gentle and advantageous.

The cleaning product 1 of the exemplary embodiment is particularly eco-friendly, because the second and third surfactants 17, 18 are each of plant origin and together make up a fraction of between 40 and 70 percent by weight of the detergent preparation 3. Furthermore, the cleaning product 1 is water-soluble and to a large degree biodegradable.

The method of the exemplary embodiment of FIGS. 1A to 1J proceeds as follows:

The detergent preparation 3, present in the form of granules 14 at ambient temperature, is applied uniformly to a first side 6 of an inner pad 5 forming an inner layer 4 (FIG. 1A). For the application of the detergent preparation 3, it is melted at a temperature beneath the melting temperature of the first surfactant 16 and thus distributed uniformly over the inner layer 4 (FIG. 1B). The detergent preparation 3 applied on the inner layer 4 is then covered by an outer pad 7 (FIG. 1C). In a subsequent step, the inner layer 4, the outer pad 7, and the detergent preparation 3 in between them are compressed together (FIG. 1D).

The assembly is subsequently turned. Then, before the application of the detergent preparation 3 (FIG. 1F), a fragrance 10 is applied, by spraying for example, to the second side 9 of the inner layer 4 (FIG. 1E). Depending on user requirement, the detergent preparation 3 of FIG. 1F may be embodied differently from the detergent preparation 3 of FIG. 1A, to produce a cleaning product 1 according to usage.

In a subsequent step, for the application of the detergent preparation 3, it is melted at a temperature beneath the melting temperature of the first surfactant 16 and so distributed uniformly together with the fragrance 10 over the second side 9 of the inner layer 4 (FIG. 1G). The detergent preparation 3 applied on the inner layer 4 is then covered by a second outer pad 11 (FIG. 1H). In a subsequent step, the inner layer 4, the outer pad 11, and the preparation 3, 10 in between them are compressed together (FIG. 1I) and cooled to form a completed cleaning product 1.

The eventual cleaning product 1 may be portioned by means of impressed cut edges, this being particularly user-friendly. Furthermore, the cleaning product 1 (FIG. 1I, 1J) has particularly good handling qualities, since the detergent preparations 3 are protected against external influences by the outer pads 7, 11 and since the user does not come into contact with skin-irritant compounds of the detergent preparations 3.

The invention generally proposes a detergent preparation 3, such as more particularly a laundry detergent preparation, which is water-soluble and which includes at least one first and one second surfactant 16, 17, the second surfactant 17 having a lower melting temperature than the first surfactant 16 and the melting temperature of the detergent preparation 3 being at least 20° C., preferably at least 40° C., below the melting temperature of the first surfactant 16.

### LIST OF REFERENCE SYMBOLS

1 cleaning product
3 detergent preparation
4 inner layer
5 inner pad
6 first side of 4 and 5
7 first outer pad
9 second side of 4 and 5
10 fragrance
11 second outer pad
13 cut edges
14 granules
16 first surfactant
17 second surfactant
18 third surfactant
19 polymer

1. A detergent preparation (3) which is water-soluble, the detergent preparation (3) comprising:
at least one first surfactant (16) and one second surfactant (17), wherein the second surfactant (17) has a lower melting temperature than the first surfactant (16) and a melting temperature of the detergent preparation (3) is at least 20° C. below the melting temperature of the first surfactant (16).

2. The detergent preparation (3) as claimed in claim 1, wherein the melting temperature of the first surfactant (16) is at least 120° C. and the melting temperature of the second surfactant (17) is at most 120° C.

3. The detergent preparation (3) as claimed in claim 1, further comprising a third surfactant (18) having a melting temperature which is below the melting temperature of the second surfactant (17).

4. The detergent preparation (3) as claimed in claim 3, wherein at least one of the first surfactant (16), the second surfactant (17), or the third (18) surfactant is anionic.

5. The detergent preparation (3) as claimed in claim 3, wherein the melting temperature of the first surfactant (16) is greater than 160° C., the melting temperature of the second surfactant (17) is not more than 100° C., and the melting temperature of the third surfactant (18) is not more than 80° C.

6. The detergent preparation (3) as claimed in claim 1, wherein the melting temperatures of the first surfactant (16) and of the second (17) surfactant differ by more than 50° C.

7. The detergent preparation (3) as claimed in claim 1, wherein the melting temperature of the detergent preparation (3) is in a range between 130° C. and 180° C.

8. The detergent preparation (3) as claimed in claim 1, wherein at least one of a) the detergent preparation (3) has a surfactant fraction of between 40 and 70 percent by weight, b) the first surfactant (16) in the detergent preparation (3) has a weight fraction of between 30 and 60 percent by weight, or c) the second surfactant (17) in the detergent preparation (3) has a weight fraction of between 7.5 and 20 percent by weight of the detergent preparation (3).

9. The detergent preparation (3) as claimed in claim 1, wherein the first surfactant (16) is sodium lauryl sulfate or a sodium lauryl sulfate derivative.

10. The detergent preparation (3) as claimed in claim 1, wherein the second (17) surfactant is of plant origin.

11. The detergent preparation (3) as claimed in claim 1, wherein the detergent preparation (3) comprises at least one polymer (19).

12. The detergent preparation (3) as claimed in claim 1, further comprising at least one of at least a temperature-stable, non-melting bleaching agent, a complexing agent, and/or a builder, an enzyme or a fragrance (10).

13. The detergent preparation (3) as claimed in claim 1, wherein at room temperature the detergent preparation is in a solid phase.

14. The detergent preparation (3) as claimed in claim 1, wherein the detergent preparation is anhydrous.

15. A method for producing a detergent preparation (3) as claimed in claim 1, the method comprising:
mixing ingredients of the detergent preparation (3) with one another in a mixing vessel at a temperature which is above a melting temperature of the detergent preparation (3), and after the mixing, cooling the melted mixture to form a solid.

16. A water-soluble cleaning product (1) comprising:
an inner layer (6, 9) and an outer pad (7, 11), and
a meltable detergent preparation (3) between a first side of the inner layer (6, 9) and the outer pad (7, 11) that is applied on the inner layer, and the outer pad (7, 11), the inner layer (6, 9), and the detergent preparation (3) are water-soluble.

17. A method for producing a water-soluble cleaning product (1) as claimed in claim 16, the method comprising:
applying the detergent preparation (3) to the inner layer (6, 9) and then covering the detergent preparation by the outer pad (7, 11) and then compressing the inner layer (6, 9), the outer layer (15), and the detergent preparation (3) in between them together.

18. The method for producing a cleaning product (1) as claimed in claim 17, wherein before the detergent preparation (3) is applied to the inner layer (6, 9), applying at least one further substance to the inner layer (6, 9), mere particularly wherein the at least one further substance comprises at least one of a temperature-stable, non-melting bleaching agent, a complexing agent, a builder, an enzyme, or a fragrance (10).

19. The method for producing a cleaning product (1) as claimed in claim 17, wherein the applying of the detergent preparation (3), further comprises either a) melting the detergent preparation (3) at a temperature beneath the melting temperature of the first surfactant (16) and then applying the detergent preparation (3) as a melt film to the inner layer (6, 9), or b) applying the detergent preparation (3) as granules (14) to the inner layer (6, 9) and then melting the detergent preparation (3) at a temperature beneath the melting temperature of the first surfactant (16).

20. The method for producing a cleaning product (1) as claimed in claim 17, wherein the inner layer (6, 9) and the detergent preparation (3) are joined to form a firm assembly at a temperature in a range between 120° C. to 240° C.
